(19) United States
(12) Patent Application Publication
(10) Pub. No.: US 2013/0065066 A1
(43) Pub. Date: Mar. 14, 2013

(54) PROTECTIVE COATINGS FOR SUBSTRATES HAVING AN ACTIVE SURFACE

(71) Applicants: Sankar Sambasivan, Chicago, IL (US); Vikram Sharad Kaul, Atlanta, GA (US)

(72) Inventors: Sankar Sambasivan, Chicago, IL (US); Vikram Sharad Kaul, Atlanta, GA (US)

(73) Assignee: APPLIED THIN FILMS, INC., Skokie, IL (US)

(21) Appl. No.: 13/699,561

(22) PCT Filed: May 10, 2011
(86) PCT No.: PCT/US11/35884

§ 371 Date: Nov. 21, 2012

Related U.S. Application Data
(60) Provisional application No. 61/348,772, filed on May 27, 2010.

(51) Int. Cl. C09D 1/00

(52) U.S. Cl. CPC C09D 1/00
USPC 428/432; 428/472.2; 427/380; 428/446; 428/701

(57) ABSTRACT

A coated substrate having a surface containing at least one active species such as an oxide to which is bonded at least one amorphous phospho-alumina layer containing an aluminum to phosphorus atomic ratio of about 0.2 to about 0.8 is bonded to at least one further amorphous phospho-alumina layer containing an aluminum to phosphorus atomic ratio of at least about 1.

### CROSS-REFERENCE TO RELATED APPLICATIONS

This application claims benefit of U.S. Provisional Application 61/348,772, filed May 27, 2010, incorporated by reference herein.

### BACKGROUND OF THE INVENTION

This invention relates to protective coatings for substrates having an active surface and more particularly relates to aluminum oxide-based protective coatings applied to substrates having an active oxide surface for use at high temperatures or in corrosive environments.

Material substrates having active surfaces include metals and metal alloys and ceramics, ceramic composites, porcelain enamels, glass ceramics, or glasses are used to produce a wide variety of useful articles, which must withstand high temperatures and/or corrosive environments for prolonged times. A substrate with an active surface typically has an active species chemically bonded to the surface material. The most typical active species used in this invention is an oxygen bonded to a transition metal element of the substrate to form an oxide. Other active species include compounds containing surface oxygen or sulfur that are present in sulfides, carbonates, hydroxides, and the like. Especially useful are articles or components, which have an active metal-oxygen species (such as an oxide) surface formed through chemical or other treatment such as heat treatment or annealing or exposure during service of the article or component. In order to protect such surfaces in corrosive conditions such as high temperature oxidation conditions, a need exists to create a stable protective barrier layer, which inhibits corrosion or oxidation.

Most metal alloys designed for service at elevated temperatures, particularly in oxidizing or corrosive environments form a chromia-rich or alumina-rich protective scale to mitigate further corrosion or oxidation. Such examples of alloys include various grades of aluminum, titanium, magnesium, and steels (including carbon and stainless steels), Inconel alloys, and nickel based alloys and superalloys that contain chromium or aluminum incorporated as an alloy constituent. However, in many alloys, presence of other alloy constituents, particularly many transition metals inhibit formation of a stable and dense protective scale. Often, the scales are composed of mixed oxides of transition metals (i.e., active oxides) and alumina or chromia. Upon further oxidation, these active oxides become unstable and go through phase transformations leading to an unstable protective scale. A protective barrier layer useful for one type of surface may not be as suitable or optimal for other types of surfaces. Thus, a barrier or protective coating formed on a pure aluminum substrate may not be as suitable if the surface of a substrate contains different or additional oxides or other metal oxygen-containing compounds. Specific examples of such substrates which are difficult to provide a suitable protective barrier include substrates having metallic oxygen compounds such as oxides or other surface species which are unstable under conditions of barrier layer formation, such as oxides or sulfides which change phases or oxidation state including those identified as transient oxides, or which have higher values of free energies of formation (−ΔG⁰¹) than corundum form of aluminum oxide (α-Al₂O₃) or are less thermodynamically stable than aluminum oxide in oxidizing environments. Active oxides may exist in metal alloy surfaces containing transition metals such as titanium, manganese, molybdenum, and vanadium.

The present invention provides a protective barrier coating on substrates having at least one surface metallic compound such as a metal oxide or non-metallic residue that is less thermodynamically stable than aluminum oxide in oxidizing environments. Similarly, certain ceramics, ceramic composites, glasses, porcelains, glass ceramics substrate materials contain oxide constituents that are less thermodynamically stable than alumina and may react or decompose during service at elevated temperature. This invention provides a protective barrier coating to stabilize the surfaces of such substrates and improve their durability in service and/or to enable surfaces which are easy to clean.

### SUMMARY OF THE INVENTION

A coated substrate having a surface containing at least one active species such as an oxide to which is bonded at least one amorphous phospho-alumina layer containing an aluminum to phosphorus atomic ratio of about 0.2 to about 0.8 is bonded to at least one further amorphous phospho-alumina layer containing an aluminum to phosphorus atomic ratio of at least about 1. Another aspect of the invention includes substrates containing alloy constituents, such as transition metals, that are susceptible to oxidation such that formation of a passivation coating is inhibited.

### BRIEF DESCRIPTION OF THE DRAWING

FIG. 1 shows Fourier transform infrared (FTIR) spectra of uncoated titanium and one layer coated titanium in accordance with this invention. In the uncoated titanium spectrum the peak (**) at 685 cm⁻¹ corresponds to Ti—O stretching. In the one layer-coated sample, peaks (*) at 1104, 1010, 957, 685, and 581 cm⁻¹ correspond to unique signature of TiPO₄ vibration modes. Additionally, in the one layer coated sample a broad peak (***) centered around 800 cm⁻¹ corresponds to a Al—O—Al bending vibration

FIG. 2 shows FTIR spectra of uncoated titanium and fully coated titanium according to the invention. In the uncoated titanium spectrum the peak (**) at 685 cm¹ corresponds to Ti—O stretching. In the fully coated sample a broad peak (*) centered around 1012 cm⁻¹ is attributed to PO₄ stretching vibrations. Additionally, a broad peak (***) centered around 805 cm⁻¹ corresponds to an Al—O—Al bending vibration.

### DESCRIPTION OF THE INVENTION

An aspect of this invention is a protective system, which uses multiple applications of phospho-alumina materials on a substrate that typically has an active surface in which the surface contains at least one active species such as an oxide. Such active species typically is an oxygen- or sulfur-containing moiety chemically bonded to a metal or contained within a non-metallic residue on a substrate. Such active surface may be a transition metal component that is susceptible to oxidation and inhibits formation of a passivation coating. Such a combination of materials and applications of those materials provide a protective system, which resists oxidation or other corrosion at high temperatures.

Passivation is a term generally used to make surfaces relatively inert from reacting with the environment such as atmospheric exposure as well as operation at high temperatures in harsh environments. For high temperatures, the term “diffusion barrier” is used most often. Known coatings prepared from a phosphorus-containing alumina act as passivation or diffusion barrier coatings where surfaces are morphologically planar and, more importantly, do not contain surface chemistries which are highly active such that they inhibit formation of a “hermetic-quality” coating. For example, alpha titanium alloys are well protected by a coating produced by heat curing an alcoholic solution of aluminum and phosphorus components with an Al/P ratio above 1. However, a similar coating on titanium alloy Ti 6242, containing different transition metal constituents and relative amounts of those constituents does not appear to form a suitable passivating layer during a heat-cure treatment of such coating. As used in this invention, a passivation coating is a surface treatment that inhibits or limits reaction of underlying substrate surface with the environment. Thus, the stabilization or passivation of the surface in accordance with this invention with a primary phosphorus-rich layer to yield a suitable passivation template is important with respect to deposition of a second layer that uses a lower phosphorus-containing alumina, which serves as a top aluminophosphate layer that is more chemically inert with respect to a high temperature environment. Without the second layer, the oxidation kinetics is severely reduced and performance is even better than known coatings. This suggests that partial or complete conversion of surface active oxides to respective phosphates is important.

Surface residue is a material that is chemically bonded to the metallic substrate, which results from chemical reaction between the metallic substrate and the environment, such a reaction with gaseous, liquid, or solid species or combination thereof. Typically, the residue may only be stable under certain service conditions (such as a reducing environment, etc.) and, when subjected to further treatment such as an oxidizing environment, the surface residue becomes active and is unstable with respect to deposition of a known passivation coating. However, using the passivation treatment described in this invention will stabilize the surface to the extent a passivation coating can be applied.

Substrates and articles containing such substrates useful in this invention include materials, such as metals and metal alloys, on which at least one active metal species such as a metal oxide may form. Also useful are substrates such as ceramics, ceramic composites, porcelain enamels, glass ceramics, or glasses, which have active surface species. For the purpose of this invention an active species is a molecular moiety containing oxygen or sulfur bonded to an element (such as a metal oxide) that is thermodynamically less stable than aluminum oxide (Al₂O₃). For example, an active oxide would have a free energy of oxide formation greater than aluminum oxide as shown on an Ellingham diagram (cf. Milton Ohring, “The Material Science of Thin Films,” Academic Press 1992, p 25, incorporated by reference herein). Preferable species contain oxygen and the most useful species useful in this invention is an oxide.

Examples of such substrates include elements of Groups 2-14 (IUPAC nomenclature) including the lanthanides. Such substrates may contain one or more elemental materials including alloys of such materials and include aluminum, titanium, vanadium, silicon, and iron, together with alloys such as iron-chromium, iron-molybdenum, iron-nickel, iron-nickel-molybdenum, iron-aluminum, iron-manganese, iron-nickel-manganese, iron-chromium-aluminum, titanium-chromium, titanium-iron, titanium-aluminum, titanium-aluminum-tin-molybdenum-zirconium, titanium-vanadium, titanium-molybdenum, titanium-manganese, iron-cobalt, and the like. Active oxides include oxides of zinc, copper, cobalt, iron, manganese, molybdenum, tungsten, vanadium, titanium, tin, niobium, nickel, tantalum, antimony, zirconium, yttrium, chromium, hafnium, magnesium, calcium, strontium, and combinations thereof.

In an aspect of this invention, an initial treatment of a phosphorus-enriched alumina with a heat curing produces a coating with phosphorus bonded to an active species such as oxygen on a substrate. This links the substrate surface through phosphorus to an aluminum-oxygen. Thus, if the active species is a metal oxide, there are metal-oxygen, phosphorus-oxygen, and aluminum-oxygen bonds, which may be shown in FTIR spectra. A secondary coating with an alumina-based material that contains less phosphorus produces a stronger protective coating against oxidation or other corrosion.

Substrates suitable for use in this invention form surfaces with at least one active species such as an oxide or sulfide. Active species may be included in carbonates, hydroxides, and sulfonates. An active metal species surface may be unstable in air or other oxidizing environment, in reducing environments, or in vacuum at elevated temperatures or at conditions in which a primary layer is formed in accordance with this invention. Typically, active species surfaces useful in this invention are unstable in oxidizing environments such as air. The preferable active surface is an active oxide surface. A typical active oxide surface may be generated or created by atmospheric exposure or chemical milling or partially oxidizing the substrate to form a reactive surface such as containing an oxide scale. Also, metal and metal alloys which experience high temperatures in use and may form an active metal compound- or metal oxide-containing scale. A typical active oxide layer on a substrate useful in this invention typically is at least 20 nanometers (nm) and typically may be up to 10 micrometers. Usually, a substrate surface useful in this invention has active metal species coverage of more than 50% and typically is more than 95% and more typically more than 99%. However, the active oxide only may be a part of a substrate scale on which the coatings of this invention are applied. In such case, the active species coverage may be less than 50%, but use of such coating will inhibit corrosion with respect to such partial coverage. Typically, an active surface, such as an active metallic oxide or other active metallic compound surface, useful in this invention is capable of forming a phosphate with at least one of the metal oxide or other metallic constituents present on the surface of the substrate, when reacted with a phosphating agent. However, as further explained, actual phosphating a surface with a conventional phosphating agent has been found to be unsuitable to forming a suitable coated substrate according to this invention.

Treatment or “phosphating” of a metal surface with phosphoric acid or solutions of metal (e.g., iron, zinc, or manganese) salts in phosphoric acid before further coating is well known. However, phosphating an active metal surface with a conventional phosphating agent such as phosphoric acid prior to coating with a phosphorus-enriched alumina in a manner described in this invention does not provide a stable, long lasting coating as provided using the dual layer coating of this invention. Conventional phosphating is conducted at near ambient temperatures under acidic conditions in which the phosphating agent will partially oxidize a metal surface or react with a metal oxide and may dissolve portions of the metal oxide. If a conventional phosphated treated surface is heated, as is typically performed in the present method, the resulting phosphating reaction occurs rapidly and less controllably and does not provide a suitable layer required for this invention. Although coatings of this invention are believed to contain chemically-bonded metal phosphate linkages at the substrate surface, a phosphating treatment with phosphoric acid does not provide the type of surface bonding as created using the phosphorus-enriched alumina dual layer of this invention. In the present invention, a stable, typically dry, phosphorus-rich material is formed and a phosphating reaction in the solid state occurs upon further thermal curing. Further, the aluminum component in the material assists in controlling release of the phosphate such that a protective passivation template layer is formed. This produces a more uniform and stable surface morphology which subsequently is passivated prior to further phospho-alumina precursor and curing treatments according to this invention.

In a further aspect of this invention, a substrate, such as a metal, may be exposed to an oxidizing environment such as contact with oxygen (including ambient air), typically at elevated temperature, prior to coating with phosphorus-enriched alumina. Partial oxidation pretreatment at elevated temperature may create a more active surface which is especially useful in forming the phosphorus-enriched alumina multi-layer as described for this invention.

Typical coated substrates of this invention are formed to have at least two layers of phospho-alumina material, which have different aluminum to phosphorous atomic ratios. In particular, a primary layer a phospho-alumina material having a low Al/P ratio is applied to a substrate having an active oxide surface and at least one further layer of a phospho-alumina material having a higher Al/P ratio is applied over the primary layer. Multiple primary low Al/P layers may be formed from multiple applications of a suitable precursor solution onto the substrate prior to forming secondary layers having higher Al/P ratios.

Typically, as described further, a phospho-alumina layer is formed by applying a precursor solution containing aluminum salt and a phosphorus oxide or ester followed by drying and curing to a suitable temperature.

A phospho-alumina precursor material useful in this invention may be formed over a wide range of aluminum to phosphorous ratios. However, a coated substrate prepared according to this invention, has a primary low Al/P (i.e. high P/Al) phospho-alumina chemically bonded to a surface oxide of the substrate in combination with a secondary upper layer of higher Al/P (lower P/Al) phospho-alumina material. The combination of low Al/P and higher Al/P layers provides a coating system with improved resistance to prolonged extreme environmental conditions such as high temperature oxidation.

In a coating system of this invention, a primary phospho-alumina layer typically has an Al/P atomic ratio of more than about 0.2 and more typically more than 0.3. Further, such primary layer typically has an Al/P atomic ratio up to about 0.8 and more typically up to about 0.7. A typical primary phospho-alumina layer has an Al/P atomic ratio of about 0.2 to 0.8 and may be about 0.4 to about 0.6.

A secondary phospho-alumina layer may be applied to the primary layer to form a coating system of this invention. Such secondary phospho-alumina layer typically has an Al/P atomic ratio of at least about 1 and more typically greater or equal to than about 2. The Al/P atomic ratio may range up to 10 or more and typically is up to about 4. A typical secondary phospho-alumina layer has an Al/P atomic ratio of about 1 to 10 and may be about 2 to about 8. Additional secondary layers may be applied, each with higher Al/P ratios.

A typical phospho-alumina coating used in this invention is about 0.1 to 1 micrometer, and preferably 0.2 to 0.6 micrometer, in thickness. Individual coating layers usually may be about 0.05 to 0.5 micrometer and typically about 0.1 to 0.3 micrometer.

Each layer of phospho-alumina material may be applied to a substrate through a precursor material with a similar Al/P atomic ratio by techniques such as spray coating, spin coating, flow coating, and vacuum-assisted infiltration. Varying substrate geometries can be accommodated via use of aforementioned techniques, including planar geometries, inner and outer surfaces of cylindrical pipes, porous structures, and complex-shaped metallic structural elements. Preferably, a uniform layer of precursor is applied followed by curing at an elevated temperature, which typically is above about 400° C. Typically, curing may be accomplished at above 500° C. and may range up to 1000° C. or more. Curing time may range from a few seconds to several hours. Typically, a precursor layer is cured at 400 to 900° C. for five to 15 minutes to form the coating material used in this invention. A precursor layer may be dried initially at 100 to 150° C. to remove volatile components. Some loss of phosphorous from the initial higher phosphorus-containing layer is expected upon exposure to higher temperatures.

The phospho-alumina coatings used in this invention typically are highly inert to chemical attack, and typically are thermally stable beyond 1400° C. High temperature oxidation tests have shown that these coatings also are highly impervious to gas (e.g. oxygen) transmission. Typically, the secondary coating layers may be deposited as a dense, pinhole-free thin coating on substrates using a simple dip, paint, spray, flow or spin coating process at relatively low temperatures (400° C. or above). As a highly covalent inorganic oxide, the coatings are chemically inert (like alumina) and thermally stable material. The coating materials are metastable (i.e. kinetically stable over a range of conditions such as temperature, but not at thermodynamic equilibrium) amorphous material stable to temperatures beyond 1200° C. Testing of the coating materials has demonstrated electrical insulating properties and continuity, hermeticity and, protective nature of the coating.

In order to form the phospho-alumina coated substrates of this invention, typically, the substrate is conditioned such that the surface of the substrate is clean in the sense of not having flakes or loose material adhering to the surface and that the surface is relatively stable for deposition of the coating such as a stable oxide of the underlying elemental substrate. Thus, if the underlying substrate is an alloy containing iron, chromium, and aluminum, the overlying oxide layer may be composed of a mixture of iron oxide, chromium oxide and aluminum oxide. Similarly, if the substrate is an alloy of titanium, aluminum, tin, zirconium and molybdenum (such as titanium alloy 6242 (ASTM designation)), the overlying oxide may be composed of a mixture of oxides of those metals, i.e., titanium oxide, aluminum oxide, tin oxide, zirconium oxide and molybdenum oxide. Another titanium alloy useful in this invention is identified as Ti64, typically referred to as Ti-6Al-4V contains aluminum and vanadium and alloy variations thereof. Metal oxide constituents, especially transition metal oxides, may exist in mixed valence states and may vary depending on the extent of oxidation. Use of this invention is especially beneficial for surfaces which contain metals in varying oxidation states or which go through phase changes with unstable morphologies. For example, titanium oxides, molybdenum oxides and manganese oxides are difficult to passivate and use of this invention is especially beneficial in forming protective coatings on surfaces containing those materials.

In an aspect of the invention, a substrate surface is cleaned or modified by physical (e.g., laser or shot peening) or chemical techniques such that the surface is composed of oxides of elements forming the substrate. A typical substrate surface useful in this invention has been contacted with a chemical agent such as an acid or alkali.

Also, the substrate may be modified through a chemical agent treatment process described as chemical milling in which portions of the substrate (e.g. a metal) are removed using a chemical milling agent such as an acid or alkali. A common manufacturing forming technique is to produce articles through treatment of the surface of a substrate through chemical action such as chemical milling or etching techniques. Such treatment may mill or assist in forming a part or article. These techniques typically produce surfaces with metal oxides or, in the case of alloys, mixed metal oxides.

In addition, a cleaned substrate surface may be partially oxidized by contacting the substrate surface with oxygen or an oxygen-containing material under oxidizing conditions of time, temperature and pressure. Such oxidation may be conducted at suitable temperatures such as between 100 and 1000° C. and for a suitable time which may range from 10 minutes to 100 hours, although other suitable ranges may be effective. Typical oxidation conditions are treatment of a substrate at 800 to 900° C. for 0.3 to 24 hours.

Layers of phosphorus-enriched aluminas or phospho-aluminas used this invention may be made typically by forming a sol-gel containing oxides of aluminum to which oxides of phosphorus are incorporated, which is cured by heating to a temperature sufficient to form a phosphate of one of the metal oxide constituents on the surface. These sol-gel precursor materials typically are formed in a non-aqueous liquid such as an alcohol (typically a C₁-C₈ alcohol or mixtures thereof and preferably ethanol) in not under strong acid conditions (pH>2). In a typical procedure, solutions of an aluminum salt (such as aluminum nitrate) and a phosphorus oxide such as phosphorus pentoxide (P₂O₅) or a phosphate ester are combined in aluminum to phosphorus atomic ratios suitable for creating a desired layer of material. Typically, concentration of the phospho-alumina material in the liquid is about 0.3 to about 1 molar (M) and typically about 0.4 to 0.6 M. Preferably, the coating materials are halide free. Examples of phosphorus-alumina coating systems are described in U.S. Pat. Nos. 6,036,762, 6,461,415, 7,311,944, 7,678,465, 7,682,700, all incorporated by reference herein.

The principal structural components of the phospho-alumina precursor solutions useful for the first or primary layer used in this invention appear to be complexes that contain M-O-P and M-O—Al linkages. The principal structural components of the phospho-alumina precursor solutions useful for secondary layers used in this invention appear to be complexes that contain Al—O—Al linkages. From analysis of ²⁷Al and ³¹P NMR data, the internal structure of the precursor materials is such that [PO₄] groups appear to be linked to [AlO₄] groups, which in turn are linked to [AlO₆] groups. Thus these materials contain tetrahedral aluminum coordination together with “distorted” octahedral aluminum, the intensity of which distortion increases with increases in excess aluminum content. This is unlike exclusive tetrahedral coordination for aluminum observed in crystalline polymorphs of AlPO₄. Fourier transform infrared (FTIR) spectroscopic data further indicate a direct linkage between [AlO₆] and [AlO₄] polyhedra. Typically, these structures reflect the structure of post-cured materials.

Thus, typically, phospho-alumina useful in this invention contain Al—O—Al linkages and contain [PO₄] tetrahedra groups linked to [AlO₄] tetrahedra groups, which in turn are linked to [AlO₆] octahedral groups. These phospho-aluminas therefore are distinct from aluminophosphate polymorphs which exist in tetrahedral coordination.

Phospho-aluminas, or otherwise described as phosphorus-enriched aluminas, useful in this invention are substantially amorphous and such amorphous character may be determined by X-ray diffraction (XRD) spectra. A substantially amorphous material does not exhibit specific XRD peaks, which can be attributed to lattice parameters of a crystalline structure.

A benefit of the invention is a protective barrier coating (such as a barrier against oxidation or other corrosion) which is securely bonded to the substrate and which remains an effective barrier coating after prolonged environmental exposures such as prolonged exposure to high temperature in an oxidative environment. Typical high temperature conditions to which coated substrates of this invention may be exposed are above 800° C., typically above 1000° C. and may exceed 1200° C. Typical substrates coated in accordance with this invention are expected to maintain corrosion resistance for hundreds to thousands of hours under high temperature oxidizing conditions.

Another benefit of the invention is for applying a coating on metal surfaces that have been subjected to service for some period of time and contain surface residue from scaling or fouling in order to limit these processes or further extend the service life and to further limit scaling or fouling. As an example, industrial processes, such as oil refining or polymer production, metal pipes in long lengths are utilized that are subjected to high temperatures in service. During routine maintenance or shutdowns, the surfaces are typically cleaned (often by pigging) wherein some or all of the surface residue is removed prior to resumption of service. The coating of the invention may be applied during the interrupted operation. Often, the surface residue contains a mixture of metallic compounds, including metallic oxides and sulfides and non-metallic build-up which are not stable and need passivation. Due to the complex and unstable nature of the surface, direct application of a passivation coating is not suitable and the coating of the invention with phosphor-rich alumina layer is highly suitable.

In production of coating of this invention, diagnostic tools to analyze the presence of the coating or its associated cure state may be used for each of the coating layer to be deposited. Spectroscopic techniques, such as Fourier transform infrared (FTIR) or Raman spectroscopic probing can provide useful information on the surface chemistry. Specific stretch or bend absorptions of metal-oxygen, P—O, and Al—O species can be identified. In particular, the first layer of the coating of this invention can be analyzed to determine if the reaction with the phosphate has occurred from the initial high temperature treatment. In the case of Ti-6242 alloy, formation of titanium phosphate, for example, can be identified with referenced peaks as shown in Example 8. Based on the spectra, it can be determined if the cure state is adequate and, if necessary, additional heat treatments can be carried out. The spectra can be taken after additional coating layers as necessary and absorption peaks identified accordingly. A portable probe, such as a Raman probe from Intevac Photonics (Mosir 950 Model) can be used to determine coating chemistry, quality, uniformity, and coverage through spatially-located probing.

Typical substrates useful in this invention are shaped articles formed from a metal or ceramic material. These articles may be solid or may contain internal pore spaces.

A purpose and function of advanced materials is based in the high stability of the materials to extremely high temperatures, which are typically above about 1000° C. Typical environments also include an oxidizing, reducing, high pressure, or vacuum atmosphere, and additional environmental components such as water (vapor or liquid), and common contaminants such as dust, dirt, sand, ash, and various organic compounds. Added requirements imposed by these environmental conditions relate to the stability of the materials with respect to conditions, such as oxidation, corrosion, embrittlement, fatigue, mechanical wear, structural changes such as sintering or densification, loss of adhesion or loss of material (mass or thickness) reduction, and chemical reaction. A coating system according to this invention protects against such environmental conditions such as prolonged high temperature oxidizing conditions.

Examples of articles coated in accordance with this invention include chromium-aluminum alloys used as construction materials for automotive catalytic converters or as high temperature components in new-generation fuel cell systems, coal combustion and turbomachinery equipment or in applications used in high temperature or oxidative environments. Other examples of articles include titanium alloys which are used in compressor components in turbine engines and power generation equipment and in exhaust structures for aircraft systems.

Aspects of the invention are illustrated but not limited by the following examples.

### EXAMPLE 1

Two coating precursor solutions were prepared having different aluminum to phosphorus atomic ratios. A first low phosphorus sol-gel precursor solution was prepared by adding 150.05 grams of aluminum nitrate nonahydrate (GFS Chemicals, Powell, Ohio) to 500 milliliters of anhydrous ethanol. In a separate container, 56.78 grams of phosphorus pentoxide (Sigma Aldrich, St. Louis, Mo.) were dissolved in 500 milliliters of anhydrous ethanol in an inert atmosphere glove box and then the two solutions were combined and stirred under reflux conditions for 16 hours. The resulting 0.4 molar (48.78 g/L) low phosphorus precursor solution had an aluminum to phosphorus atomic ratio of 1.

A second phosphorus-rich sol-gel precursor solution was prepared by adding 187.56 grams of aluminum nitrate nonahydrate (GFS Chemicals, Powell, Ohio) to 500 milliliters of anhydrous ethanol. In a separate container, 141.94 grams of phosphorus pentoxide (Sigma Aldrich, St. Louis, Mo.) were dissolved in 500 milliliters of anhydrous ethanol in an inert atmosphere glove box and then the two solutions were combined and stirred under reflux conditions for 16 hours. The resulting 0.5 molar (96.46 g/L) phosphorus-rich precursor solution had an aluminum to phosphorus atomic ratio of 0.5.

### EXAMPLE 2

In a manner described in Example 1, two coating precursor solutions were prepared having different aluminum to phosphorus atomic ratios. A first low phosphorus sol-gel precursor solution was prepared using 150.05 grams of aluminum nitrate nonahydrate and 28.38 grams of phosphorus pentoxide separately dissolved ethanol. The resulting combined, stirred, and refluxed 0.4 molar (34.59 g/L) low phosphorus precursor solution had an aluminum to phosphorus atomic ratio of 2.

Also in a manner described in Example 1, a second phosphorus-rich sol-gel precursor solution was prepared using 187.56 grams of aluminum nitrate nonahydrate and 141.94 grams of phosphorus pentoxide separately dissolved in ethanol. The resulting combined, stirred, and refluxed 0.5 molar (96.46 g/L) phosphorus-rich precursor solution had an aluminum to phosphorus atomic ratio of 0.5.

### EXAMPLE 3

In a manner described in Example 1, two coating precursor solutions were prepared having different aluminum to phosphorus atomic ratios. A first low phosphorus sol-gel precursor solution was prepared using 150.05 grams of aluminum nitrate nonahydrate and 5.68 grams of phosphorus pentoxide separately dissolved in ethanol. The resulting combined, stirred, and refluxed 0.4 (23.23 g/L) molar low phosphorus precursor solution had an aluminum to phosphorus atomic ratio of 10.

Also in a manner described in Example 1, a second phosphorus-rich sol-gel precursor solution was prepared using 187.56 grams of aluminum nitrate nonahydrate and 141.94 grams of phosphorus pentoxide separately dissolved in ethanol. The resulting combined, stirred, and refluxed 0.5 molar (96.46 g/L) phosphorus-rich precursor solution had an aluminum to phosphorus atomic ratio of 0.5.

### EXAMPLE 4

In a manner described in Example 1, two coating precursor solutions were prepared having different aluminum to phosphorus atomic ratios. A first low phosphorus sol-gel precursor solution was prepared using 150.05 grams of aluminum nitrate nonahydrate and 56.78 grams of phosphorus pentoxide separately dissolved in ethanol. The resulting combined, stirred, and refluxed 0.4 molar (48.78 g/L) low phosphorus precursor solution had an aluminum to phosphorus atomic ratio of 1.

Also in a manner described in Example 1, a second phosphorus-rich sol-gel precursor solution was prepared by using 187.56 grams of aluminum nitrate nonahydrate and 283.88 grams of phosphorus pentoxide separately dissolved in ethanol. The combined, stirred, and refluxed 0.5 (167.83 g/L) molar phosphorus-rich precursor solution had an aluminum to phosphorus atomic ratio of 0.25.

### EXAMPLE 5

A substrate sample made from iron-chromium-aluminum alloy was cleaned by sequentially ultrasonicating the sample in acetone, methanol, and isopropanol for approximately 15 minutes each. The sample was oven dried at 120° C. The sample was heated in a furnace which was ramped to 800° C. at 10 degrees ° C./minute and held at that temperature for 20 minutes. The sample was dip coated by immersing the sample in the phosphorus-rich solution of Example 1 for one minute and then slowly retracting the coated sample. This first layer coating was dried with a heat gun positioned about 2.5 cm from the surface, which was heated to a temperature below about 250° C., for two minutes on each side and then further dried in an oven at 120° C. for 20 minutes under ambient conditions. The dried sample was slowly inserted into a tube furnace maintained at 500° C. for 5 minutes then the furnace temperature was ramped to 900° C. at 10 degrees ° C./minute and held for 5 minutes. After cooling, the first layer coated sample was dip coated in the low phosphorus precursor solution of Example 1, slowly withdrawn from the solution, and then dried in an oven at 120° C. for 15 minutes under ambient conditions. The resulting two-layer coated sample was heated in a furnace maintained at 500° C. for 15 minutes under ambient conditions to obtain a fully cured state.

### EXAMPLE 6

A two-layer coated sample substrate as prepared in accordance with Example 2 was inserted into a tube furnace heated to 900° C. and held for 24 hours in ambient air. The sample was slowly cooled in the furnace to 300° C. and weighed. The results of similar oxidation tests with an uncoated sample and a sample tested after pre-oxidation only are shown in Table 1. The results show that the uncoated sample had the largest weight gain due to oxidation. The pre-oxidized sample did show some improvement in oxidation resistance (as shown by weight gain). However, the coated sample of the invention demonstrated substantially improved oxidation resistance as shown by lower weight gain.

TABLE 1

| Sample | Average weight gain (wt. %) |
|---|---|
| Uncoated | 3.24 ± 0.32 |
| Pre-oxidized | 2.04 ± 0.24 |
| Two layer coated Ex. 6 | 0.65 ± 0.48* |

*Based on pre-oxidized sample

### EXAMPLE 7

A substrate sample made from Titanium 6242 alloy was cleaned by sequentially ultrasonicating the sample in deionized water, acetone, and methanol for approximately 10 minutes each. After the sample was oven dried at 120° C. The sample was dip coated by immersing the sample in a phosphorus-rich precursor solution prepared in the manner described in Example 1 for one minute and the slowly retracting at the coated sample at a rate of 0.2 cm/s. This first layer coating was dried with a heat gun for 1.5 minutes and then further dried in an oven at 120° C. for 20 minutes. The dried sample was slowly inserted into a furnace maintained at 500° C. for 5 minutes. After cooling, the first layer coated sample was dip coated in a low phosphorus precursor solution prepared in manner as described in Example 1, slowly withdrawn from the solution at 0.2 cm/s, heat-gun dried for 1.5 minutes, and the dried in an oven at 120° C. for 20 minutes. The resulting two-layer coated sample was cured in a 500° C. furnace for 5 minutes.

### EXAMPLE 8

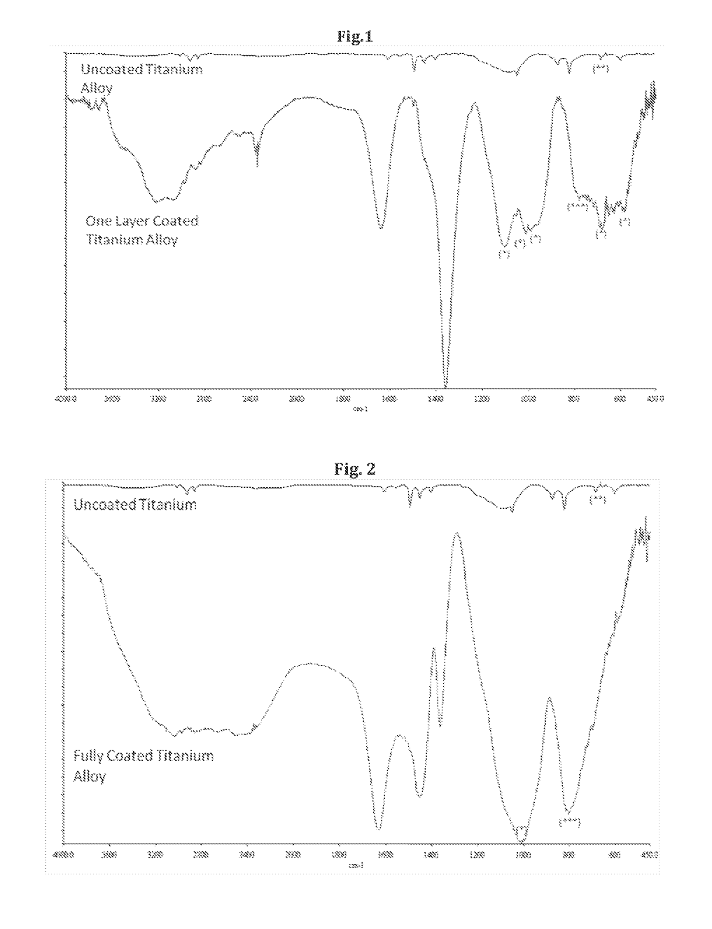

A substrate sample made from Titanium 6242 alloy was cleaned by sequentially ultrasonicating the sample in deionized water, acetone, and methanol for approximately 10 minutes each. After the sample was oven dried at 120° C. The sample was dip coated by immersing the sample in a phosphorus-rich precursor solution prepared in the manner described in Example 2 for one minute and the slowly retracting at the coated sample at a rate of 0.2 cm/s. This first layer coating was dried with a heat gun for 1.5 minutes and then further dried in an oven at 120° C. for 20 minutes. The dried sample was slowly inserted into a furnace maintained at 500° C. for 5 minutes. FIG. 1 shows the FTIR spectra of an uncoated and coated Ti6242 with characteristic absorption peaks, after the first layer coating, indicating the formation of titanium phosphate whereas the peaks corresponding to the uncoated show Ti—O stretch frequency. After cooling, the first layer coated sample was dip coated in a low phosphorus precursor solution prepared in manner as described in Example 2, slowly withdrawn from the solution at 0.2 cm/s, heat-gun dried for 1.5 minutes, and the dried in an oven at 120° C. for 20 minutes. The resulting two-layer coated sample was cured in a 500° C. furnace for 5 minutes. FIG. 2 is representative FTIR spectra of the fully coated Ti-6242 showing absorption peaks corresponding to presence of P-0 and Al—O bonds.

### EXAMPLE 9

A substrate sample made from Titanium 6242 alloy was cleaned by sequentially ultrasonicating the sample in deionized water, acetone, and methanol for approximately 10 minutes each. After the sample was oven dried at 120° C. The sample was dip coated by immersing the sample in a phosphorus-rich precursor solution prepared in the manner described in Example 3 for one minute and the slowly retracting at the coated sample at a rate of 0.2 cm/s. This first layer coating was dried with a heat gun for 1.5 minutes and then further dried in an oven at 120° C. for 20 minutes. The dried sample was slowly inserted into a furnace maintained at 500° C. for 5 minutes. After cooling, the first layer coated sample was dip coated in a low phosphorus precursor solution prepared in manner as described in Example 3, slowly withdrawn from the solution at 0.2 cm/s, heat-gun dried for 1.5 minutes, and the dried in an oven at 120° C. for 20 minutes. The resulting two-layer coated sample was cured in a 500° C. furnace for 5 minutes.

### EXAMPLE 10

A substrate sample made from Titanium 6242 alloy was cleaned by sequentially ultrasonicating the sample in deionized water, acetone, and methanol for approximately 10 minutes each. After the sample was oven dried at 120° C. The sample was dip coated by immersing the sample in a phosphorus-rich precursor solution prepared in the manner described in Example 4 for one minute and the slowly retracting at the coated sample at a rate of 0.2 cm/s. This first layer coating was dried with a heat gun for 1.5 minutes and then further dried in an oven at 120° C. for 20 minutes. The dried sample was slowly inserted into a furnace maintained at 500° C. for 5 minutes. After cooling, the first layer coated sample was dip coated in a low phosphorus precursor solution prepared in manner as described in Example 4, slowly withdrawn from the solution at 0.2 cm/s, heat-gun dried for 1.5 minutes, and the dried in an oven at 120° C. for 20 minutes. The resulting two-layer coated sample was cured in a 500° C. furnace for 5 minutes.

### EXAMPLE 11

The two-layer coated sample substrates prepared in accordance with Examples 4, 7, 8, 9, and 10 were inserted into a tube furnace heated to 650° C. and held for 800 hours in ambient air. The samples were removed from the furnace and the malleability or degree of embrittlement was qualitatively measured and recorded by mechanically cutting the sample together with the rate of weight change. Table 2 shows the results of similar oxidation tests with an uncoated sample, a sample dipped only in the phosphorus-rich solution, and a sample phosphated by submersion in 85% by weight phosphoric acid solution for 10 minutes followed by an ethanol rinse and drying at 120° C. for 1 hour. The results show that embrittlement of an uncoated sample due to oxidation was the most severe. The sample with only the phosphorus-rich solution and the phosphoric acid treated sample show some improvement in oxidation resistance over the uncoated (as shown by the retention of metallic appearance); however, the coated sample of the invention demonstrated substantially improved oxidation resistance as shown by the metallic appearance and lack of brittle cracking during cutting after exposure and the lower weight gain rates.

TABLE 2

| | Weight Gain Rate | Qualitative Mechanical |
|---|---|---|
| | ((% weight change/ | Cut Test |
| Sample | hour) × 10⁻⁶) | Observations |
| Uncoated | 30 | Gray and oxidized surface, |
| | | extremely brittle, significant |
| | | cracking and shard formation |
| | | during cutting |
| Phosphorus-rich | 10 | Still somewhat metallic in |
| only | | appearance, brittle with some |
| | | cracking during cutting |
| Phosphoric acid | 20 | Still somewhat metallic in |
| treated | | appearance, brittle with |
| | | cracking during cutting |
| Two layer coated | 8 | Dark colored but still metallic in |
| Ex. 7 | | appearance, cuts without |
| | | cracking, still somewhat |
| | | malleable |
| Two layer coated | 10 | Dark, but still metallic in |
| Ex. 8 | | appearance |
| Two layer coated | 9 | Dark colored but still malleable |
| Ex. 9 | | and ductile when cut |
| Two layer coated | 10 | Gray/brown, still ductile when |
| Ex. 10 | | cut |

1: A coated substrate having a surface containing at least one active species to which is bonded at least one amorphous phospho-alumina layer containing an aluminum to phosphorus atomic ratio of about 0.2 to about 0.8 which is bonded to at least one further amorphous phospho-alumina layer containing an aluminum to phosphorus atomic ratio of at least about 1.

2: A coated substrate of claim 1 in which the active species is an active oxide.

3: A coated substrate of claim 1 in which the substrate is a metal or a metal alloy.

4: A coated substrate of claim 1 which the substrate is a ceramic, a ceramic composite, a glass, a porcelain enamel, or a glass-ceramic.

5: A coated substrate of claim 1 in which an active oxide is formed by partially oxidizing the substrate surface.

6: A coated substrate of claim 1 in which the substrate is chemically milled to form a surface containing an active oxide.

7: A coated substrate of claim 2 in which the active oxide is selected from a Group 2-14 oxide that is thermodynamically less stable than aluminum oxide.

8: A coated substrate of claim 2 in which at least one active oxide is an oxide of zinc, copper, cobalt, iron, manganese, molybdenum, tungsten, vanadium, titanium, tin, niobium, nickel, tantalum, antimony, zirconium, yttrium, chromium, hafnium, magnesium, calcium, strontium, or combinations thereof.

9: A coated substrate of claim 8 in which the active oxide surface has oxides of molybdenum, manganese, or combinations thereof.

10: A coated substrate of claim 8 in which the substrate surface contains an active oxide of titanium, aluminum, molybdenum, tin, and zirconium.

11: A method to produce a protective coating on a substrate surface containing at least one active species comprising applying an alcoholic solution of a phosphate oxide or ester and an aluminum salt in which the Al/P atomic ratio is 0.2 to 0.8 to a substrate having an active species surface, drying and curing the applied solution to form a primary layer and further applying to the primary layer an alcoholic solution of a phosphorus oxide or ester and an aluminum salt in which the Al/P atomic ratio is at least 1 and drying and curing the applied solution to form a secondary layer.

12: A method of claim 11 in which in which each layer is cured at a temperature of at least 400° C.

13: A method of claim 11 in which more than one primary or secondary layer is applied.

14: A shaped article having a surface containing at least one active oxide to which is bonded at least one amorphous phospho-alumina layer containing an aluminum to phosphorus atomic ratio of about 0.2 to about 0.8 which is bonded to at least one further amorphous phospho-alumina layer containing an aluminum to phosphorus atomic ratio of at least about 1.

15: An article of claim 14 formed from an iron-chromium-aluminum alloy.

16: An article of claim 14 formed from a titanium alloy.

17: A coated substrate of claim 1 in which the substrate is a titanium-aluminum-molybdenum-tin-zirconium alloy substrate or a titanium-aluminum-vanadium alloy having a surface containing at least one active oxide to which is bonded at least one amorphous phospho-alumina layer containing an aluminum to phosphorus atomic ratio of about 0.2 to about 0.8.

18: A coated substrate of claim 1 in which the surface containing at least one active species to which is bonded at least one primary amorphous phospho-alumina layer containing an aluminum to phosphorus atomic ratio of about 0.3 to about 0.6.

19: A method of claim 11 in which in which the primary layer has an Al/P atomic ratio of about 0.3 to 0.6.

20: An article of claim 16 formed from a titanium-aluminum-molybdenum-tin-zirconium alloy.
